(19) United States
(12) Patent Application Publication
(10) Pub. No.: US 2006/0277067 A1
(43) Pub. Date: Dec. 7, 2006

(54) Exercise stress estimation method for increasing success rate of exercise prescription

(75) Inventors: Woo-young Jang, Seoul (KR); Hong-jun Eoh, Gyeongju-si (KR); Myung-hwan Yun, Seoul (KR); Young-bo Suh, Daegu-si (KR); Kyung-ho Kim, Yongin-si (KR); Hong-sig Kim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/371,007

(22) Filed: Mar. 9, 2006

(30) Foreign Application Priority Data
Jun. 7, 2005 (KR) 10-2005-0048571

(51) Int. Cl. G06Q 10/00; A63B 71/00; G06Q 50/00

(52) U.S. Cl. 705/2; 482/8

(57) ABSTRACT

A method of estimating stress caused by an exercise includes receiving questionnaire data including body measurements from a user, measuring health measurement data, deducing an exercise target and an exercise prescription based on the received and measured data, and transmitting the exercise target and exercise prescription to the user. The questionnaire data is then received back from the user, including the body measurements from the user and measuring again the health measurements data.; Parameters are designed based on the received and re-received questionnaire data and the measured and re-measured health measurement data and the parameters are converted to predetermined values. A regression analysis model is designed for estimating the exercise stress using the parameters and performing regression analysis and the exercise stress estimated through the regression analysis is transmitted to the user.

### CROSS-REFERENCE TO RELATED PATENT APPLICATIONS

This application claims the priority of Korean Patent Application No. 10-2005-0048571, filed on Jun. 7, 2005, in the Korean Intellectual Property Office, the disclosure of which is incorporated herein in its entirety by reference.

### BACKGROUND OF THE INVENTION

1. Field of the Invention

The present invention relates to a method of estimating stress caused by an exercise, and more particularly, to a method of estimating stress caused by an exercise, which allows an increase in the success rate of an exercise prescription.

2. Description of the Related Art

As the economy has improved, interest in health and exercise has increased. Physical strength can be built up and health can be improved through appropriate exercise, but improper exercise could result in damage to health. Thus, there is required an individualized exercise prescription which decides exercise type, the time of day to exercise, exercise duration and exercise intensity, considering individual conditions, for example, a level of physical strength, a health status, and age.

Various individualized exercise prescriptions have been investigated, and several related inventions have been made. For instance, Korean Patent Laid-open Gazette No. 10-2004-0092834 discloses a system and method for providing an individualized exercise prescription service by which an exercise model optimized for a client is provided online and the client exercises while playing games offline. This invention provides a variety of health information and prescriptions for client conditions over the Internet, but since after the initial stage, only the operating duration and speed of a treadmill are received as additional information, health information and a prescription optimized for the changed health status of the client cannot be provided.

Korean Patent Laid-open Gazette No. 10-2005-0007093 discloses a measurement device with a biofeedback function which informs a user of current measurements and allows the user to easily know a history of the measurements and measurements predicted based on the history in real-time when the measurement device is used and a method of processing and displaying the measurements, wherein the measurement device may be a height measuring device, a scale, a blood pressure measurement device, a blood sugar measurement device or body fat measurement device which is used for obtaining a variety of health information.

Further, Korean Patent Laid-open Gazette No. 10-2002-0019229 relates to a health management system based on a network which allows a user to easily check his/her health status and provides data such as exercise type, quantity of exercise, and reduction of weight using a program differentiated according to the user's health status.

Korean Patent Laid-open Gazette No. 10-2003-0067234 discloses an expert system for providing a knowledge-based exercise prescription. The expert system provides a scientific exercise prescription deciding quality and quantity of exercise according to a variety of characteristics of an individual. This invention can improve the effects of exercise or provide a prediction model showing the figure of the individual before and after exercise with an avatar by indirectly predicting an individual's exercise capability.

As described above, the conventional inventions related to the individualized exercise prescription prescribe an exercise based on questionnaire data obtained from a user and adjust the exercise prescription over time as the user's physical condition data changes. The effect of the exercise can be improved for a short period by using the conventional inventions, but if the stress of the exercise is severe, the success rate of exercise prescription is reduced in the long run. In other words, the conventional inventions do not consider the stress felt by the individual who performs the prescribed exercise.

### SUMMARY OF THE INVENTION

Illustrative, non-limiting exemplary embodiments of the present invention overcome the above disadvantages, and other disadvantages not described above.

A method consistent with the present invention estimates stress caused by an exercise, allowing an increase in the success rate of exercise prescription during performance of exercise according to an individualized exercise prescription.

According to an aspect of the present invention, there is provided a method of estimating stress caused by an exercise which comprises receiving questionnaire data including body measurements from a user, measuring health measurement data, deducing an exercise target and an exercise prescription based on the received and measured data, and transmitting the exercise target and exercise prescription to the user. The method further includes

receiving again the questionnaire data including the body measurements from the user and measuring again the health measurements data,

designing parameters based on the received and re-received questionnaire data and the measured and re-measured health measurement data and converting the parameters to predetermined values,

designing a regression analysis model for estimating the exercise stress using the parameters and performing regression analysis;

and transmitting the exercise stress estimated through the regression analysis to the user.

According to another aspect of the present invention, there is provided a method of estimating stress caused by an exercise comprising: receiving questionnaire data from a user, measuring the user's health measurement data, deducing an exercise target and an exercise prescription on the basis of the received and measured data, and transmitting the exercise target and exercise prescription to the user;

receiving current questionnaire data from the user or measuring the current health measurements data and evaluating the level of achievement of the exercise target in three levels;

receiving the number of days for which the user performs the prescribed exercise and evaluating the level of performance of prescribed exercise in three levels;

deducing a new exercise prescription and transmitting the exercise prescription to the user when the evaluated level of achievement of the exercise target is determined as low or the evaluated level of performance of the prescribed exercise is determined as low; when the evaluated level of achievement of the exercise target is determined as medium, the evaluated level of performance is determined as medium or high and the user requests a new exercise prescription; and when the evaluated level of achievement of the exercise target is determined as high, the evaluated level of performance is medium and the user requests a new exercise prescription; and

estimating the exercise stress through regression analysis when the evaluated level of achievement of the exercise target is determined as medium, the evaluated level of performance is determined as medium or high and the user does not request a new exercise prescription; when the evaluated level of achievement of the exercise target is determined as high, the evaluated level of performance is determined as medium and the user does not request a new exercise prescription; and when the evaluated level of achievement of the exercise target is determined as high and the evaluated level of performance is determined as high.

### BRIEF DESCRIPTION OF THE DRAWINGS

The above and other features and advantages of the present invention will become more apparent and more readily appreciated from the following description of exemplary embodiments thereof, with reference to the attached drawings in which:

FIG. 1 is a flowchart illustrating a method of estimating exercise stress according to an exemplary embodiment of the present invention;

FIG. 2 is a flowchart illustrating a method of estimating exercise stress according to another exemplary embodiment of the present invention;

FIG. 3 is a graph of an example of a regression analysis model used in the method of FIG. 1;

FIG. 4 is a graph illustrating changes in weight for explaining the evaluation of the exercise target achievement of FIG. 2; and

FIG. 5 is a graph illustrating the number of days for which a user performs a prescribed exercise, and is used for explaining the evaluation of the level of performance of prescribed exercise of FIG. 2.

### DETAILED DESCRIPTION OF THE INVENTION

The present invention will now be described more fully with reference to the accompanying drawings, in which exemplary embodiments of the invention are shown.

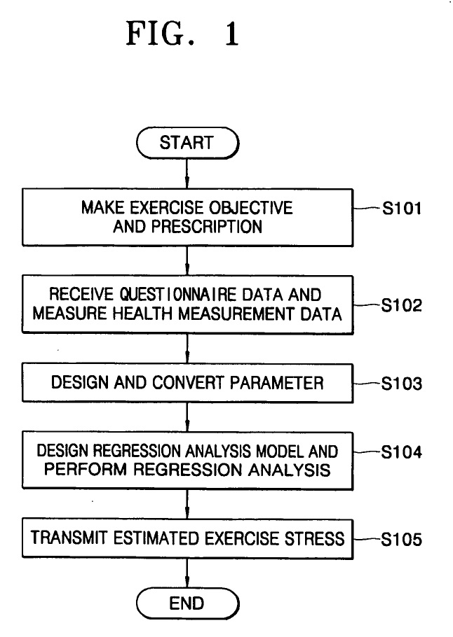

FIG. 1 is a flowchart illustrating a method of estimating exercise stress according to an exemplary embodiment of the present invention.

Referring to FIG. 1, in the method of estimating exercise stress, questionnaire data including body measurements is input by a user, health measurement data is measured, and an exercise target and exercise prescription are deduced based on the data and then transmitted to the user (operation S101).

The questionnaire data includes at least one of physical information including body measurements, diet information, information about exercise habits, and lifestyle information. More specifically, the physical information may be height, weight, girth of the chest, waist measurement, hip measurement, age or sex, and the diet information may be information about whether the user has breakfast, lunch, and supper, the user's eating habits, and the user's favorite foods and least favorite foods. Further, the information about exercise habits may be information about whether the user usually exercises, and if so, exercise type, exercise duration, exercise frequency, and exercise intensity. The lifestyle information may be information about the hour of rising and sleeping of the user. Moreover, the questionnaire data may include information about the user's exercise target and exercise preference.

The health measurement data may include one or more of blood pressure, body fat percentage, an electrocardiogram and a blood sugar level. The health measurement data can be input from any source. That is, the data may be input after it is personally measured by the user or measured in a medical facility.

In the method according to the present embodiment, the exercise target is established based on the input questionnaire data or the measured health measurement data, and then exercise is prescribed according to the exercise target.

The exercise target may be to increase or reduce the body measurements or health measurements. Specifically, the exercise target may be to reduce weight, waist measurement, blood pressure, body fat percentage, and a blood sugar level, or to increase the girth of the chest.

The exercise prescription may include one or more of exercise types, time of day to exercise, exercise duration and exercise intensity. The exercise type may include one or more of aerobic exercise, weight training and stretching exercise. The time of day to exercise may be the morning, noon, or evening. The unit of the time duration may be, for example, 10 minutes. The exercise intensity is, for example, in the case of a treadmill, the running speed.

The user who has received the exercise prescription in the above operation exercises according to the exercise prescription.

Referring to FIG. 1 again, the questionnaire data is received again from the user and then the health measurement data is measured (operation S102).

Next, parameters are designed based on the data obtained in the above operations S101 and S102 and converted to predetermined values (operation S103).

The parameters designed in the present operation are regression analysis parameters. The parameters may be changes in health measurements, changes in body measurements, or habit information.

The changes in health measurements may be changes in one or more of weight, body fat percentage, the electrocardiogram and blood sugar level. Changes in health measurements are categorized into three levels, which are a level of not more than 1% of target measurements, a level of more than 1% but not more than 3% of target measurements, and a level of more than 3% of target measurements.

Regarding body measurements, one or more of weight, waist measurement, and hip measurement may change. Changes in body measurements can be evaluated using Expression (1) when the measurements are increased, and evaluated using Expression (2) when the measurements are reduced.
[(target measurements)−(measurements after exercise)]÷[(target measurements)−(measurements before exercise)] (1)
[(target measurements)−(measurements before exercise)]÷[(target measurements)−(measurements after exercise)] (2)

The habit information may include one or more of diet information, information about exercise habits and lifestyle information.

The parameters may be converted into values between 0 and 1 in operation S103. The parameters may be converted through standardization.

For instance, the changes in health measurements categorized into three levels, which are not more than 1% of target measurements, more than 1% but not more than 3% of target measurements, and more than 3% of target measurements, can be converted into values between 0 and 1, for example, 1, 0.67, and 0.33, using a linear distribution method. The changes in body measurements evaluated using Expressions (1) and (2) can have values between 0 and 1. The habit information may be converted to 0 when the habit is regular, and converted to 1 when the habit is irregular.

Referring to FIG. 1 again, a regression analysis model is designed to estimate the exercise stress using the parameters designed and converted in the above operation, and then the regression analysis is performed (operation S104).

The regression model may be represented by Expression (3).
Exercise stress=exp[α×((health measurement change)×β+(body measurement change)×γ+(habit)×δ)]/{1+exp[α×((health measurement change)×β+(body measurement change)×γ+(habit)×δ)]} (3)

where α denotes an exercise prescription index, β denotes a health measurement index, γ denotes a body measurement index, and δ denotes a habit index.

Subsequently, the exercise stress estimated from the regression analysis is transmitted to the user (operation S105).

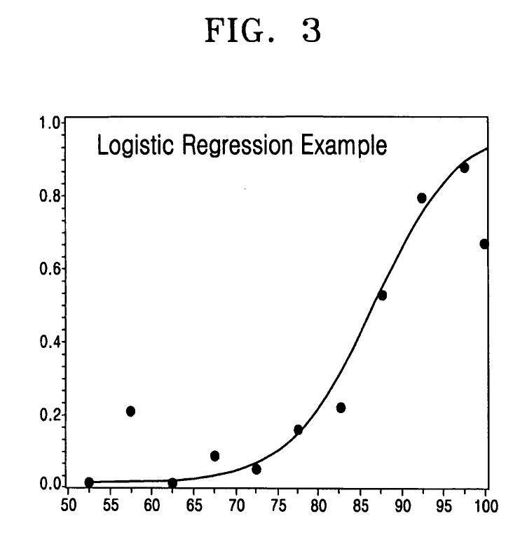

FIG. 3 is a graph of an example of the regression analysis model used in the method of estimating the exercise stress shown in FIG. 1.

It is known that the regression analysis model is remarkably successful in prediction of trend data, and since the data value is converted between 0 and 1, a reliable prediction result is provided even when differences between data are so large that the scattering is widely dispersed. Thus, this model allows the changed health measurements of the user to be stably converted, and accurate prediction results to be obtained.

By using the exercise stress measured through the above operations, the success rate of the exercise prescription can be increased.

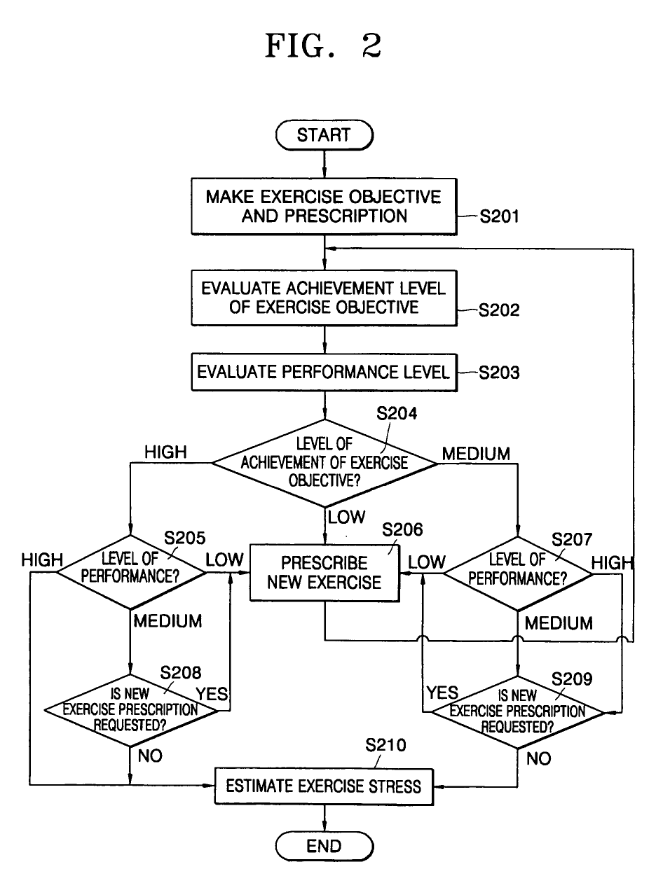

FIG. 2 is a flowchart illustrating a method of estimating exercise stress according to another exemplary embodiment of the present invention.

Referring to FIG. 2, questionnaire data is received from a user, health measurement data is measured, an exercise target and the exercise prescription are deduced based on the received and measured data, and the exercise target and exercise prescription are transmitted to the user (operation S201).

The questionnaire data includes at least one of physical information including body measurements, diet information, information about exercise habits, and lifestyle information. More specifically, the physical information may be height, weight, girth of the chest, waist measurement, hip measurement, age or sex. The diet information may be information about whether the user has breakfast, lunch, and supper, and the user's eating habits, and the user's favorite foods and least favorite foods.

Further, the information about exercise habits may be information about whether the user usually exercises, and if so, exercise type, exercise duration, exercise frequency, and exercise intensity. The lifestyle information may be information about the hour of rising and sleeping. Moreover, the questionnaire data may include information about the user's exercise target and exercise preference.

The health measurement data may include one or more of blood pressure, body fat percentage, an electrocardiogram and a blood sugar level. The health measurement data can be input from any source. That is, the data may be input after it is personally measured by the user or measured in a medical facility.

In the method according to the present embodiment, the exercise target is established on the basis of the input questionnaire data or the measured health measurement data, and then exercise is prescribed according to the exercise target.

The exercise target may be to increase or reduce the body measurements or health measurements. Specifically, the exercise target may be to reduce weight, waist measurement, blood pressure, body fat percentage, and a blood sugar level, or to increase the girth of the chest.

The exercise prescription may include one or more of exercise type, time of day to exercise, exercise duration and exercise intensity. The exercise type may include one or more of aerobic exercise, weight training and stretching exercise.

The time of day to exercise may be in the morning, noon, or evening. The unit of the time duration may be, for example, 10 minutes. The exercise intensity is, for example, in the case of a treadmill, the running speed.

The user who has received the exercise prescription in the above operation exercises according to the exercise prescription.

Referring to FIG. 2 again, the current questionnaire data is received from a user or the current health measurements data is measured, and the level of achievement of the exercise target is evaluated and categorized into three levels (operation S202).

When the exercise target is to lower the measurements, the level of achievement of the exercise target may be evaluated as high when a value obtained from Expression (4) is more than 0.2; as medium when a value obtained from Expression (4) is more than −0.2 but not more than 0.2; or as low when a value obtained from Expression (4) is not more than −0.2.
[(initial measurement)−(current measurement)]÷[(initial measurement)−(target measurement)] (4)

On the contrary, when the exercise target is to increase the measurements, the level of achievement of the exercise target may be evaluated as high when a value obtained from Expression (5) is more than 0.2; as medium when a value obtained from Expression (5) is more than −0.2 but not more than 0.2, or as low when a value obtained from Expression (5) is not more than −0.2.
[(current measurement)−(initial measurement)]±[(target measurement)−(initial measurement)] (5)

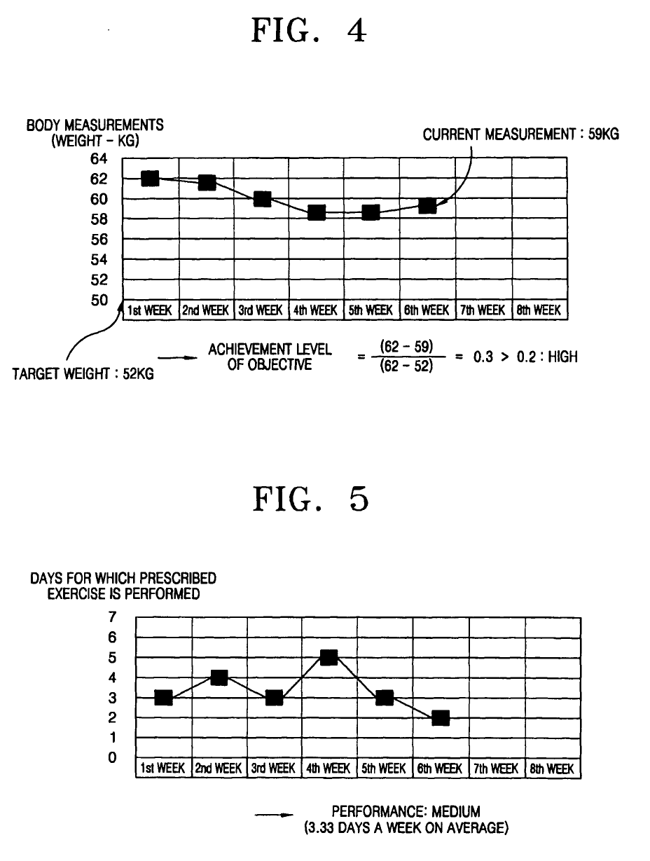

FIG. 4 is a graph illustrating changes in weight for explaining the evaluation of the exercise target achievement of FIG. 2.

Referring to FIG. 4, the exercise target is to reduce the weight to 52 kg. The initial weight of the user is 62 kg when the user receives the exercise prescription and starts to exercise, and a current weight of the user six weeks after starting the exercise is 59 kg. Since the user's exercise target is to reduce weight, the current level of achieving the exercise target is measured by Expression (4) and the value of Expression (4) is 0.3 which is over 0.2, and therefore the achievement of the exercise target is evaluated as high.

Referring to FIG. 2 again, the number of days for which the user exercises according to the exercise prescription is input by the user and how frequently the user performs the exercise according to the exercise prescription is evaluated and categorized into three levels based on the number of days.

The level of performance of prescribed exercise may be evaluated as high when the user performs the prescribed exercise an average of 4 days or more per week; as medium when the user performs the prescribed exercise an average of less than 4 but not less than 3 days per week; or as low when the user performs the prescribed exercise an average of less than 3 days per week.

FIG. 5 is a graph illustrating the number of days for which the user performs the prescribed exercise, and is used for explaining the evaluation of the level of performance of the prescribed exercise of FIG. 2.

Referring to FIG. 5, the exercise according to the exercise prescription is performed 3.33 days a week on average. Therefore, the level of performance of prescribed exercise is evaluated as medium.

Referring to FIG. 2 again, a new exercise prescription is deduced or exercise stress is estimated through regression analysis on the basis of the evaluated level of achievement of the exercise target and level of performance of prescribed exercise or whether the user requests a new exercise prescription.

Specifically, when the evaluated level of achievement of the exercise target is determined as low in operation S204 or the evaluated level of performance of the prescribed exercise is determined as low in operation S205 or operation S207, a new exercise prescription is deduced in operation S206 and the new prescription is transmitted to the user. Also, when the evaluated level of achievement of the exercise target is determined as medium in operation S204, the evaluated level of performance is determined as medium or high in operation S207 and the user requests a new exercise prescription (illustrated as ‘yes’ in operation S209), a new exercise is prescribed in operation S206 and the new prescription is transmitted to the user. Further, when the evaluated level of achievement of the exercise target is determined as high in operation S204, the evaluated level of performance is determined as medium in operation S205 and the user requests a new exercise prescription (illustrated as ‘yes’ in operation S208), a new exercise is prescribed in operation S206 and the new prescription is transmitted to the user.

The method according to the present embodiment may further include receiving the information about the user's preference for prescription together with the request for the new exercise prescription. The information about the preference for prescription may include whether the user is satisfied with one or more of the existing exercise types, time of day to exercise, exercise duration, and exercise intensity.

Meanwhile, when the evaluated level of achievement of the exercise target is determined as medium in operation S204, the evaluated level of performance is determined as medium or high in operation S207 and the user does not request a new exercise prescription (illustrated as ‘no’ in operation S209), the exercise stress is estimated through regression analysis in operation S210. Also, when the evaluated level of achievement of the exercise target is determined as high in operation S204, the evaluated level of performance is determined as medium in operation S205 and the user does not request a new exercise prescription (illustrated as ‘no’ in operation S209), the exercise stress is estimated through regression analysis in operation S210. Further, when the evaluated level of achievement of the exercise target is determined as high in operation S204 and the evaluated level of performance is determined as high in operation S205, the exercise stress is estimated through regression analysis in operation S210.

The estimation of the exercise stress through regression analysis may be executed by modifying the method illustrated in FIG. 1.

The operation of estimating the exercise stress through regression analysis may include the operations of designing parameters from the received data and converting the parameters; designing a regression analysis model for estimation of exercise stress estimation by using the parameters and performing the regression analysis; and transmitting the exercise stress estimated through the regression analysis to the user.

The designed parameters are regression analysis parameters. The parameters may be changes in health measurements, changes in physical measurement, or habit information.

The health measurements changes may be changes in one or more of weight, body fat percentage, the electrocardiogram and blood sugar level. The changes in health measurements are categorized into three levels, which are not more than 1% of target measurements, more than 1% but not more than 3% of target measurements, and more than 3% of target measurements.

The body measurement changes may be changes in one or more of weight, waist measurement, and hip measurement. Changes in body measurements can be evaluated using Expression (1) when the measurements are increased, and evaluated using Expression (2) when the measurements are reduced.
[(target measurements)−(measurements after exercise)]÷[(target measurements)−(measurements before exercise)] (1)
[(target measurements)−(measurements before exercise)]÷[(target measurements)−(measurements after exercise)] (2)

The habit information may include one or more of the diet information, information about exercise habits and lifestyle information.

The parameters may be converted into values between 0 and 1. The method of converting the parameters has been described above.

The regression model may be represented by Expression (3).
Exercise stress=exp[α×((health measurement change)×β+(body measurement change)×γ+(habit)×δ)]/{1+exp[α×((health measurement change)×β+(body measurement change)×γ+(habit)×δ)]} (3)

where α denotes an exercise prescription index, β denotes a health measurement index, γ denotes a body measurement index, and δ denotes a habit index. Each index has been described above.

The method of estimating the exercise stress can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices, but the computer readable recording medium is not limited thereto.

According to the present invention, an individual exercise stress is measured and estimated when exercise is performed according to an individualized exercise prescription, and thus, the success rate of the exercise prescription can be increased.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of estimating stress caused by an exercise comprising:
receiving questionnaire data including body measurements from a user, measuring health measurement data, deducing an exercise target and an exercise prescription based on the received and measured data, and transmitting the exercise target and exercise prescription to the user;
receiving again the questionnaire data including the body measurements from the user and measuring again the health measurements data;
designing parameters based on the received and re-received questionnaire data and the measured and re-measured health measurement data and converting the parameters to predetermined values;
designing a regression analysis model for estimating the exercise stress using the parameters and performing regression analysis; and
transmitting the exercise stress estimated through the regression analysis to the user.

2. The method of claim 1, wherein the questionnaire data includes one or more of physical information including the body measurements, diet information, information about exercise habits and lifestyle information.

3. The method of claim 1, wherein the health measurement data includes one or more of blood pressure, body fat percentage, an electrocardiogram and blood sugar level.

4. The method of claim 1, wherein the exercise target is to increase or reduce the body measurements or health measurements.

5. The method of claim 1, wherein the exercise prescription includes one or more of exercise type, time of day to exercise, exercise duration and exercise intensity.

6. The method of claim 5, wherein the exercise type includes one or more of aerobic exercise, weight training and stretching exercise.

7. The method of claim 1, wherein the parameters are changes in health measurements, changes in body measurements, and habit information.

8. The method of claim 7, wherein the changes in health measurements include changes in one or more of blood pressure, body fat percentage, electrocardiogram and blood sugar level.

9. The method of claim 7, wherein the changes in health measurements are categorized into three levels, which are not more than 1% of target measurements, more than 1% but not more than 3% of the target measurements and more than 3% of the target measurements.

10. The method of claim 7, wherein the changes in body measurements include changes in one or more of weight, the girth of the chest, waist measurement and hip measurement.

11. The method of claim 7, wherein the changes in body measurements are evaluated using Expression (1) when the measurements are increased or evaluated using Expression (2) when the measurements are reduced, wherein:
[(target measurements)−(measurements after exercise)]÷[(target measurements)−(measurements before exercise)] (1)
[(target measurements)−(measurements before exercise)]÷[(target measurements)−(measurements after exercise)] (2).

12. The method of claim 7, wherein the habit information includes one or more of diet information, information about exercise habits and lifestyle information.

13. The method of claim 1, wherein the predetermined values are between 0 and 1.

14. The method of claim 1, wherein the regression analysis model is represented by Expression (3)
Exercise stress=exp[α×((health measurement change)×β+(body measurement change)×γ+(habit)×δ)]/{1+exp[α×((health measurement change)×β+(body measurement change)×γy+(habit)×δ)]} (3)
where α denotes an exercise prescription index, β denotes a health measurement index, γ denotes a body measurement index, and δ denotes a habit index.

15. A method of estimating stress caused by an exercise comprising:
receiving questionnaire data from a user, measuring the user's health measurement data, deducing an exercise target and an exercise prescription on the basis of the received and measured data, and transmitting the exercise target and exercise prescription to the user;
receiving current questionnaire data from the user or measuring the current health measurements data and evaluating the level of achievement of the exercise target in three levels;
receiving the number of days for which the user performs the prescribed exercise and evaluating the level of performance of prescribed exercise in three levels;
deducing a new exercise prescription and transmitting the exercise prescription to the user when the evaluated level of achievement of the exercise target is determined as low or the evaluated level of performance of the prescribed exercise is determined as low; when the evaluated level of achievement of the exercise target is determined as medium, the evaluated level of performance is determined as medium or high and the user requests a new exercise prescription; and when the evaluated level of achievement of the exercise target is determined as high, the evaluated level of performance is medium and the user requests a new exercise prescription; and
estimating the exercise stress through regression analysis when the evaluated level of achievement of the exercise target is determined as medium, the evaluated level of performance is determined as medium or high and the user does not request a new exercise prescription; when the evaluated level of achievement of the exercise target is determined as high, the evaluated level of performance is determined as medium and the user does not request a new exercise prescription; and when the evaluated level of achievement of the exercise target is determined as high and the evaluated level of performance is determined as high.

16. The method of claim 15, wherein the questionnaire data includes one or more of physical information including body measurements, diet information, information about exercise habits and lifestyle information.

17. The method of claim 15, wherein the health measurement data includes one or more of blood pressure, body fat percentage, an electrocardiogram and blood sugar level.

18. The method of claim 15, wherein the exercise target is to increase or reduce the body measurements or health measurements.

19. The method of claim 15, wherein the exercise prescription includes one or more of exercise type, time of day to exercise, exercise duration and exercise intensity.

20. The method of claim 15, wherein the exercise type includes one or more of aerobic exercise, weight training and stretching exercise.

21. The method of claim 15, wherein when the exercise target is to lower the measurements, the level of the achievement of the exercise target is evaluated as high when a value obtained from Expression (4) is more than 0.2; as medium when a value obtained from Expression (4) is more than −0.2 but not more than 0.2; and as low when a value obtained from Expression (4) is not more than −0.2, wherein
[(initial measurement)−(current measurement)]÷[(initial measurement)−(target measurement)] (4).

22. The method of claim 15, wherein when the exercise target is to increase the measurements, the level of the achievement of the exercise target is evaluated as high when a value obtained from Expression (5) is more than 0.2; as medium when a value obtained from Expression (5) is more than −0.2 but not more than 0.2; and as low when a value obtained from Expression (5) is not more than −0.2, wherein
[(current measurement)−(initial measurement)]÷[(target measurement)−(initial measurement)] (5).

23. The method of claim 15, wherein the level of performance of prescribed exercise is evaluated as high when the user performs the prescribed exercise an average of 4 days or more a week; as medium when the user performs the prescribed exercise an average of less than 4 but not less than 3 days a week; or as low when the user performs the prescribed exercise an average of not more than 3 days a week.

24. The method of claim 15, wherein, when the new exercise is prescribed and transmitted to the user, information about the user's preference for prescription is additionally received together with the request for the new exercise prescription from the user.

25. The method of claim 24, wherein the information about the user's preference for prescription includes one or more of the existing exercise type, time of day to exercise, exercise duration and exercise intensity.

26. The method of claim 15, wherein the estimating of the exercise stress comprises:
designing parameters from the received data and converting the parameters;
designing a regression analysis model for estimation of the exercise stress by using the parameters and performing regression analysis; and
transmitting the exercise stress estimated through the regression analysis to the user.

27. The method of claim 26, wherein the parameters are changes in health measurements, changes in body measurements, and habit information.

28. The method of claim 27, wherein the changes in health measurements include changes in one or more of blood pressure, body fat percentage, an electrocardiogram and blood sugar level.

29. The method of claim 27, wherein the changes in health measurements are categorized into three levels, which are not more than 1% of target measurements, more than 1% but not more than 3% of the target measurements and more than 3% of the target measurements.

30. The method of claim 27, wherein the changes in body measurements include changes in one or more of weight, the girth of the chest, waist measurement and hip measurement.

31. The method of claim 27, wherein the changes in body measurements are evaluated using Expression (1) when the measurements are increased or evaluated using Expression (2) when the measurements are reduced, wherein
[(target measurements)−(measurements after exercise)]÷[(target measurements)−(measurements before exercise)] (1)
[(target measurements)−(measurements before exercise)]÷[(target measurements)−(measurements after exercise)] (2).

32. The method of claim 27, wherein the habit information includes one or more of diet information, information about exercise habits and lifestyle information.

33. The method of claim 26, wherein the parameters are converted into values between 0 and 1.

34. The method of claim 26, wherein the regression analysis model is represented by Expression (3), wherein
Exercise stress=exp[α×((health measurement change)×β+(body measurement change)×γ+(habit)×δ)]/{1+exp[α×((health measurement change)×β+(body measurement change)×γ+(habit)×δ)]} (3)
where α denotes an exercise prescription index, β denotes a health measurement index, γ denotes a body measurement index, and δ denotes a habit index.

35. A computer readable recording medium having embodied thereon a computer program for executing the method of claim 1.

36. A computer readable recording medium having embodied thereon a computer program for executing the method of claim 15.
